(19) United States
(12) Patent Application Publication
(10) Pub. No.: US 2009/0107579 A1
(43) Pub. Date: Apr. 30, 2009

(54) Loading system

(76) Inventors: ROBIN E. SMITH, Stanley, NC (US); BRANDON CORY HOOVER, Cornelius, NC (US); NATALIA JOHNSON, Statesville, NC (US); CHRISTOPHER JOHN PARKE, Cornelius, NC (US); GEORGE ANDREW HARTEL, Huntersville, NC (US); MATTHEW SHUTE, Charlotte, NC (US)

Correspondence Address: TAFT, STETTINIUS & HOLLISTER LLP, SUITE 1800, 425 WALNUT STREET, CINCINNATI, OH, 45202-3957, US

(21) Appl. No.: 11/978,052

(22) Filed: Oct. 26, 2007

(51) Int. Cl. B67C 3/00; B44D 3/00; F04B 33/00

(52) U.S. Cl. 141/67; 15/257.06; 417/437

(57) ABSTRACT

A paint loading system including a pump and a tray that are releasably mounted on a paint container. The pump is used to discharge paint into the tray, where the paint can be loaded onto an applicator. The tray drains excess paint into the container. The loading system may include a removable tray having surface features aiding in the transfer of paint to the applicator. The loading system includes a spout allowing paint to be poured from the paint container without necessitating the removal of the loading system from the paint container.

### BACKGROUND OF THE INVENTION

This invention relates generally to the field of paint trays and, more particularly, to trays used in transferring paint to applicators such as brushes, rollers, pads, and the like.

Prior art paint trays of various shapes and sizes are used to load various types of applicators with paint. These paint trays typically require that paint be poured from a paint can into a tray and any excess paint remaining in the tray after use must be poured back into the paint can or discarded.

### BRIEF SUMMARY OF THE INVENTION

Embodiments of the present invention provide a paint loading system that may include a pump and a tray that are releasably mounted on a paint container. The pump may be used to discharge paint into the tray, where the paint may be loaded onto an applicator. The tray may drain excess paint into the container. Other features of the invention may include a removable tray having surface features aiding in the transfer of paint to the applicator. The loading system may include a spout allowing paint to be poured from the paint container without necessitating the removal of the loading system from the paint container.

In a first aspect of the present invention, a loading system may include a base adapted to couple with a container holding a liquid, a tray supported by the base, and a pump adapted to discharge a portion of the liquid onto the tray.

The tray may include a liquid return adapted to drain liquid from the tray into the container. The tray may include one or more surface features. The tray may include a sloped floor, the pump may discharge the liquid proximate a high portion of the tray, and the liquid return may be located proximate a low portion of the tray. The tray may be adapted to load the portion of the liquid onto an applicator. The applicator may be a brush, roller, edger, cloth, corner painting tool, or pad. The surface features may include a plurality of truncated cones. At least one of the truncated cones may include a hole such that liquid may flow from within the tray to beneath the tray through the hole.

The base may include at least one barb adapted to engage the container. The tray may be releasably attached to the base. The displacement of the pump may be approximately equal to the volume of liquid necessary to load an applicator. The pump may be a positive displacement pump comprising a piston slidable within a cylinder. The base may include a spout adapted to allow pouring of the liquid from the container while the loading system is attached to the container. The container may be a can, a bucket, or a bottle.

The base may be adapted to releasably couple with the container and the base may include at least one barb adapted to engage the container and a spout adapted to allow pouring of the liquid from the container while the loading system is attached to the container. The tray may be releasably attached to the base and may include a liquid return located proximate a low portion of the tray adapted to allow liquid to drain from the tray into the container, a sloped floor, and at least one surface feature including a plurality of truncated cones wherein at least one of the truncated cones includes a hole such that liquid may flow from within the tray to beneath the tray through the hole. The pump may be a positive displacement pump comprising a piston slidable within a cylinder, the pump may discharge the portion of liquid proximate a high portion of the tray, and a displacement of the pump may be approximately equal to a volume of liquid necessary to load an applicator. The container may be a can, a bucket, or a bottle. The applicator may be a brush, roller, edger, cloth, corner painting tool, or pad.

In a second aspect, a loading system may include a base adapted to releasably couple with a container holding a liquid, a first tray adapted to releasably couple with the base and having at least one surface feature, and a pump adapted to withdraw a portion of the liquid from the container and discharge the portion of the liquid into the first tray. The base and the tray may cooperate to allow drainage from the tray into the container.

In a detailed embodiment of the second aspect, a loading system may further include a second tray adapted to releasably couple with the base in place of the first tray such that the pump discharges the portion of the liquid into the second tray. The second tray may have at least one surface feature that is different from at least one surface feature of the first tray.

In a third aspect, a method of loading an applicator with a liquid may include the steps of providing a container holding a liquid; providing a loading system, the loading system including a pump adapted to pump the liquid and a tray adapted to receive liquid discharged from the pump; coupling the loading system to the container; operating the pump to discharge a portion of the liquid onto the tray; providing an applicator; loading the applicator with at least some of the portion of the liquid in the tray.

In a detailed embodiment of the third aspect, the liquid may include paint, stain, oil, sealant, coating, and/or epoxy. In another detailed embodiment of the third aspect, the applicator may include a brush, roller, cloth, edger, corner applicator, and/or pad.

In yet another detailed embodiment of the third aspect, the method may further include the steps of operating the pump a second time and loading the applicator a second time following the completion of the step of loading the applicator. The method may further include the step of priming the pump prior to operating the pump to discharge a portion of the liquid onto the tray.

These and other aspects and advantages of the present invention will become apparent to those skilled in the art upon consideration of the following detailed description of exemplary embodiments exemplifying of the invention as presently perceived.

### BRIEF DESCRIPTION OF THE SEVERAL VIEWS OF THE DRAWINGS

The detailed description particularly refers to the accompanying Figures in which:

FIG. 1 is an exploded isometric view of an exemplary embodiment of the present invention loading system;

FIG. 2 is a side elevation view of an exemplary embodiment of the present invention loading system installed on a paint can;

FIG. 3 is a rear elevation view of an exemplary embodiment of the present invention loading system installed on a paint can;

FIG. 4 is a cross sectional view of an exemplary embodiment of the present invention loading system installed on a can;

FIG. 5 is a plan view of an exemplary embodiment of the present invention loading system; and

FIG. 6 is a cross sectional view of an exemplary embodiment of the present invention loading system.

### DETAILED DESCRIPTION OF THE INVENTION

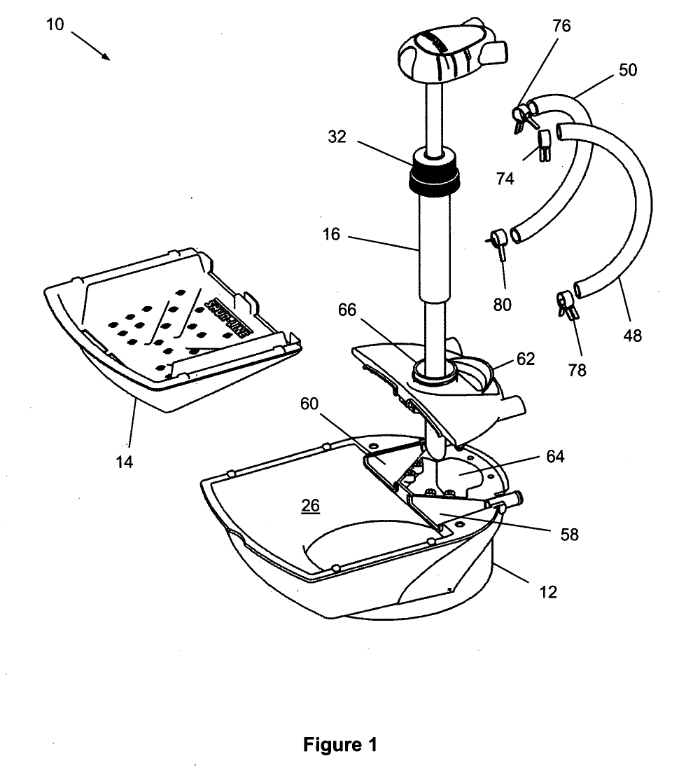

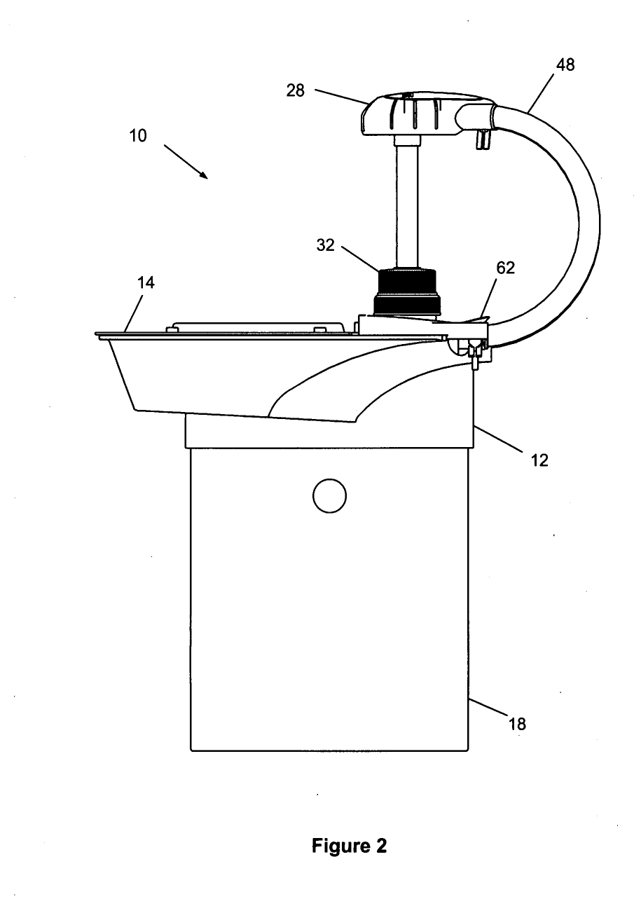

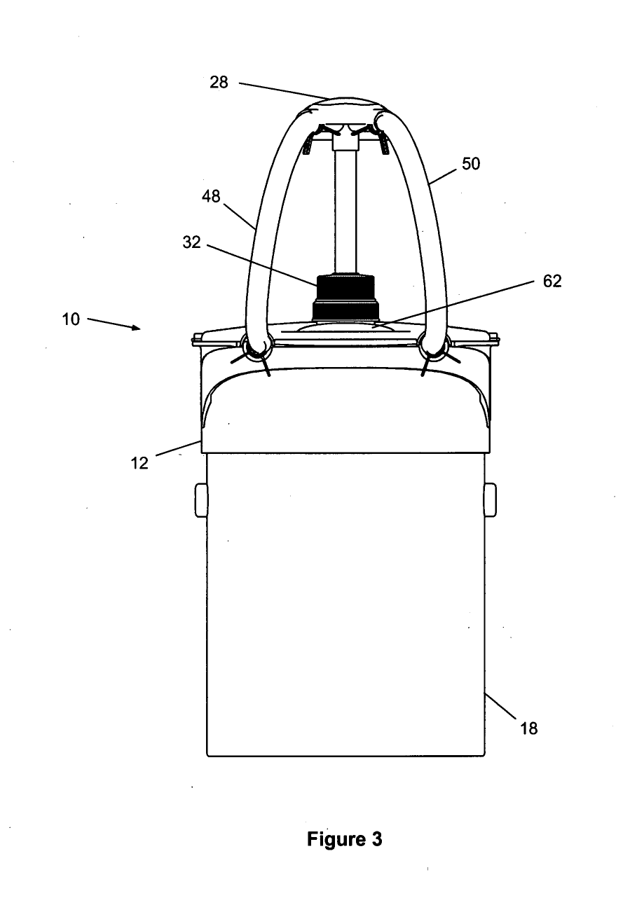

FIG. 1 depicts an exemplary embodiment of the present invention loading system 10. The exemplary embodiment includes a base 12, a tray 14, and a pump 16. As shown in FIGS. 2-4, the loading system 10 is adapted to couple with a container 18 holding a fluid. In the exemplary embodiment, container 18 is a standard one gallon (3.61 liter) paint can. It is within the scope of the invention for the base 12 to be adapted to couple with other containers, such as, but not limited to, cans of other sizes (e.g., a one pint can), buckets (e.g., a five gallon (18.92 liter) bucket), and/or bottles.

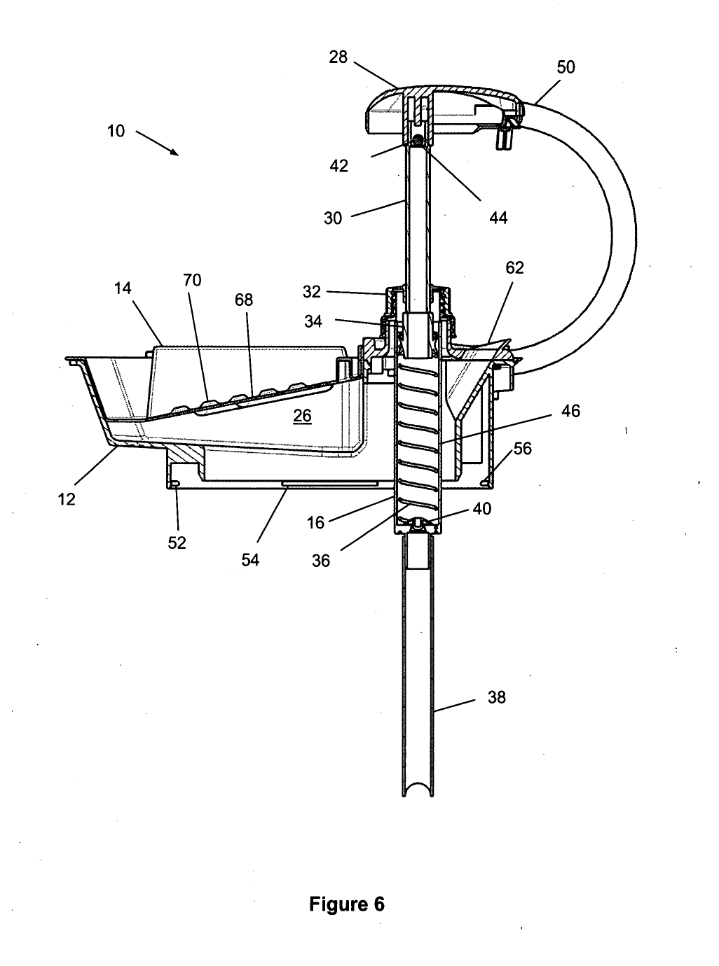

In the exemplary embodiment, base 12 couples with container 18 using rounded barbs 52, 54, 56 as shown in FIG. 6. The exemplary embodiment utilizes four rounded barbs, only three of which are visible in FIG. 6. The base 12 may utilize other attachment means (such as, but not limited to, other elastically-deformable features on the base 12, a friction fit between the base 12 and the container 18, and/or one or more gaskets interposed between base 12 and container 18) in place of or in addition to rounded barbs 52, 54, 56.

In the exemplary embodiment, base 12 includes a threaded portion 66 adapted to couple with collar 32 on the pump 16. Other means (such as, but not limited to, threaded fasteners, snap-fit components, and/or friction-fit components) may be used in place of or in addition to threaded portion 66 and collar 32 to couple the pump 16 to the base 12.

In the exemplary embodiment, base 12 includes spout 62 in fluid communication with the interior of container 18 via opening 64. Spout 62 is adapted to allow pouring of the fluid in container 18 without the need to remove the loading system 10 from the container 18. For example, a user may wish to pour paint from a paint can into a large roller tray while leaving the loading system attached to a paint can. The loading system may include an alternative pouring means (such as, but not limited to, a spout located on the side wall of base 12) or no pouring means on base 12. Further, the pump 16 may be adapted to discharge liquid into another receptacle, such as a large roller tray.

In the exemplary embodiment, base 12 includes ports 58, 60 which are adapted to convey liquid from tubing 48, 50 to tray 14. In the exemplary embodiment, ports 58, 60 are divergent along the flow path of the liquid such that the liquid is dispersed along a substantial portion of the width of the tray 12. In other embodiments, the loading system may not include such ports or the loading system may include one or more ports having other configurations (such as, but not limited to a single port and/or non-diverging ports).

In the exemplary embodiment, the base 12 is made of molded plastic. Such a composition may reduce the difficulty of cleaning the loading system after use. The base 12 may be constructed of other durable or disposable materials.

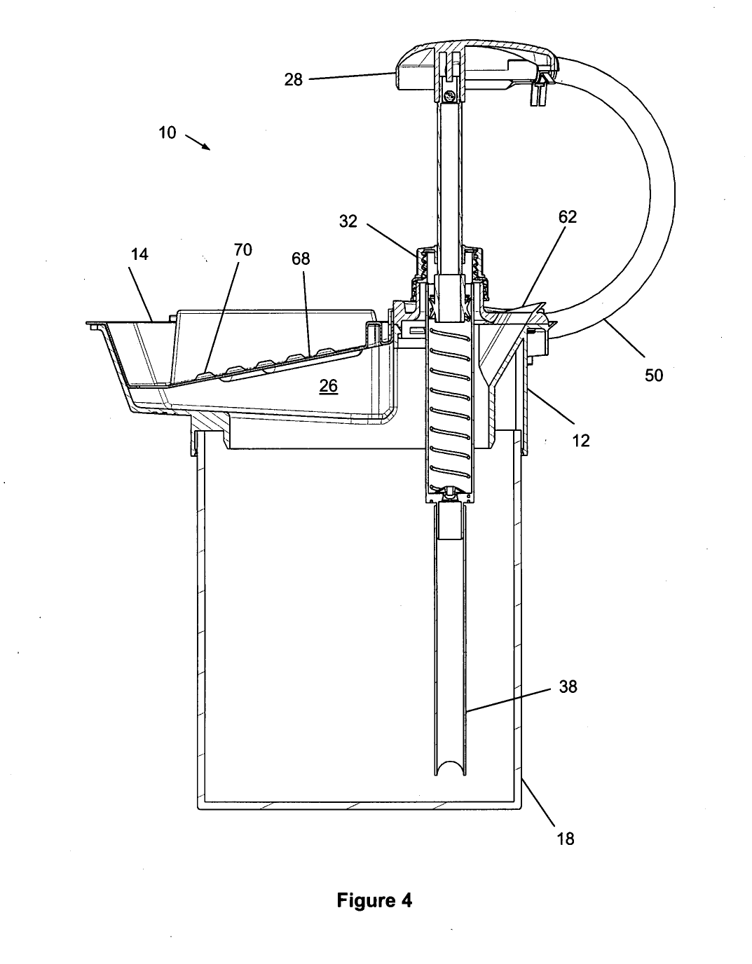

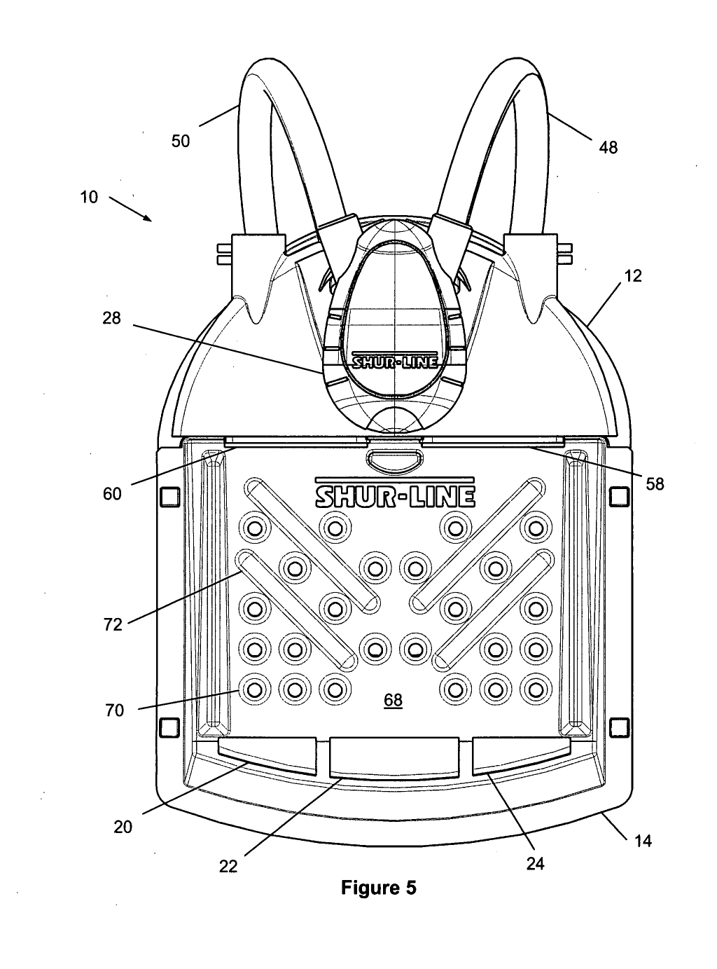

In the exemplary embodiment, tray 14 is adapted to releasably fit within cavity 26 in base 12 as shown in FIGS. 4 and 6. In other embodiments, tray 14 may be attached to base 12 such that tray 14 is not readily removable. Further, the tray 14 may be constructed integrally with the base 12. As shown in FIG. 5, the exemplary embodiment tray 14 is generally rectangular in shape. One or more trays of different shapes (such as, but not limited to, square, triangular, circular, semi-circular, etc.) may be used in place of or in addition to tray 14.

In the exemplary embodiment, the floor 68 of tray 14 is sloped such that the portion near the pump 16 is higher than the portion farther from the pump 16. The slope of the floor 68 of the exemplary embodiment tray 14 is apparent in FIGS. 4 and 6. It is within the scope of the invention to utilize a tray have a level floor and/or a tray with a steeper or shallower sloped floor.

As shown in FIG. 5, the exemplary embodiment tray 14 includes liquid return slots 20, 22, 24. Return slots 20, 22, 24 allow liquid to drain from the tray 14 into container 18 via cavity 26 in base 12. In other embodiments, tray 14 may have no return slots or may have one or more return means of other shapes in addition to or in place of return slots 20, 22, 24.

As shown in FIGS. 4-6, the exemplary embodiment tray 14 includes a plurality of surface features on its floor 68. In the exemplary embodiment, these surface features include cones 70 and ribs 72. The cones 70 are truncated and each includes a cylindrical hole extending from the interior of the tray 14 into cavity 26 below. These holes allow liquid to drain from the tray 14 into the container 18 via cavity 26. In the exemplary embodiment, the cones are 0.210 inches high. Other embodiments may incorporate no surface features or surface features of other shapes (such as, but not limited to, partial or full hemispheres, non-truncated cones, etc.) in addition to or in place of the cones 70 and ribs 72. The surface features may include depressions relative to the floor of the tray and/or may include raised portions above the floor of the tray. Further, other embodiments may utilize holes of other shapes in the various surface features and may utilize surface features without holes. The size, shape, height, and other characteristics of the surface features may be adapted to produce desirable results when loading different applicators, such as, but not limited to, brushes, rollers, pads, cloths, edgers, corner applicators, etc. It is within the scope of the invention to provide interchangeable, removable trays having differing characteristics (such as, but not limited to, size, shape, and/or surface features) such that a user may selectively utilize a tray 14 specifically adapted for certain applicators.

In the exemplary embodiment, tray 14 is made of molded plastic. Such a composition may reduce the difficulty of cleaning the loading system after use. The tray 14 may be constructed of other durable or disposable materials. It is within the scope of the invention to utilize a reusable tray 14 and to utilize single-use trays 14 or a single- use liner adapted to fit tray 14.

As shown in FIG. 6, the exemplary embodiment pump 16 includes a handle 28 attached to the top end of a hollow shaft 30. The shaft 30 is attached to a piston 34 which is slidable within a cylinder 46. The shaft 30 slides through a collar 32, which is adapted to secure the pump 16 to the threaded portion 66 of the base 12. The collar 32 may include a sealing means (such as, but not limited to, one or more gaskets or rings) to prevent any liquid present above the piston 34 from leaking between shaft 30 and collar 32.

In the exemplary embodiment, the outer perimeter of the piston 34 forms a seal with the inner surface of the cylinder 46. It is within the scope of the invention to include a sealing means (such as, but not limited to, one or more gaskets or rings) between the piston 34 and the cylinder 46.

In the exemplary embodiment, a helical compression spring 36 biases the piston 34 in the upward direction. The spring 36 is made of an elastic metal and is interposed between piston 34 and the bottom end of cylinder 46. The helical compression spring 36 may be replaced or supplemented by another biasing device or may be eliminated.

In the exemplary embodiment, a suction tube 38 extends from the bottom of cylinder 46. The suction tube 38 is structurally rigid such that it does not collapse when the pressure within the suction tube 38 is less than the pressure outside the suction tube 38 during operation of the pump.

The exemplary embodiment pump 16 includes two one-way valves: intake valve 40 and a discharge valve comprising a ball 42 and a seat 44. Intake valve 40 is made of a flexible material (such as, but not limited to, rubber or thermoplastic resin) and is adapted to allow flow from suction tube 38 into cylinder 46 and to prevent flow from cylinder 46 into suction tube 38. The discharge valve comprises a glass ball 42 and a corresponding seat 44. The discharge valve is adapted to allow flow from within shaft 30 to within handle 28 and to prevent flow from within handle 28 to within shaft 30. In other embodiments, the arrangement and type of valves utilized may vary from that of the exemplary embodiment.

In the exemplary embodiment, handle 28 is connected to base 12 via two tubes 48, 50. The tubes 48, 50 are made of flexible, clear vinyl and have an interior diameter of 03/8″. The tubes 48, 50 are attached to handle 28 and base 12 using tubing clamps 74, 76, 78, 80. The tubing clamps 74, 76, 78, 80 are metal spring clamps. The tubes 48, 50 are sufficiently long to allow a full stroke of pump 16 without crimping. It is within the scope of the invention to utilize alternative means to connect the pump 16 to the base 12 (such as, but not limited to, a single tube connecting the handle 28 to the base 12, a direct connection between the discharge of pump 16 and base 12, a nozzle on the pump 16 that deposits the liquid discharged from the pump 16 into the tray 14 using gravity, etc.) Further, it is within the scope of the invention to utilize tubing made of alternative materials (or colors) and alternative attachment means.

In the exemplary embodiment, the displacement of the pump is approximately equal to the volume of liquid necessary to properly load an edger. In some embodiments, the pump may be adapted to deliver the appropriate volume of liquid to load a specific applicator. In other embodiments, the pump may have a displacement other than the volume of liquid necessary to properly load a specific applicator. Further, it is within the scope of the invention to utilize a pump that is capable of delivering a volume less than its maximum displacement, such as by a partial stroke of the pump handle.

In the exemplary embodiment, the pump 16 is made of molded plastic with the exception of the components described herein as being composed of other materials. Such a composition may reduce the difficulty of cleaning the loading system after use. The pump 16 may be constructed of other durable or disposable materials. Further, the pump 16 may be adapted to couple with a faucet to allow flushing with water.

It is within the scope of the invention to include a pump of a different type than that described above. For example, the pump may be, without limitation, a peristaltic, impeller, or diaphragm pump as are well known in the art. Further, it is within the scope of the invention for the pump to be motor driven and/or manually operated.

The exemplary embodiment loading system may be operated as follows. A user removes the lid from a can of paint and prepares the paint for use (by properly stirring the paint, for example). The user couples the loading system 10 onto the paint can 18 as shown in FIG. 2.

The user primes the pump 16 by depressing handle 28, causing handle 28, shaft 30, and piston 34 to move downward. This motion is opposed by spring 36. Once the user has fully depressed the handle 28, the user releases handle 28. Spring 36 exerts an upward force on piston 34, causing the paint in the paint can 18 to be drawn upward through the suction tube 38 and the intake valve 40 into the cylinder 46. Several strokes of the handle 28 may be necessary to fill the entire flow path with paint.

The user then operates pump 16 by depressing and then releasing handle 28. After the pump 16 has been primed, depressing handle 28 causes paint within the cylinder 46 to flow upward through the shaft 30. The upward flow lifts ball 42 off of seat 44 allowing paint to flow past the ball 42 and into tubes 48, 50. The paint flows through tubes 48, 50 and into ports 58, 60. Ports 58, 60 allow the paint to flood into the tray 14. When the user releases handle 28, spring 36 pushes the piston upwards, thereby drawing paint from the paint can 18 into the cylinder 46 in preparation for the next downward stroke of the piston 34.

The surface features of the floor 68 of tray 14 retain an appropriate amount of paint for loading an edger and the excess paint drains into the paint can 18 via the return slots 20, 22, 24 and the holes in the cones 70. The user loads an edger (or another applicator) with paint from the tray 14 and uses the edger to apply paint to a surface. The user may operate the pump 16 as necessary to supply paint to the tray 14 for loading the edger.

Although the exemplary embodiment described above is adapted for use with a one gallon paint can, it is within the scope of the invention to use the loading system with other liquids (such as, but not limited to, stain, oil, sealant, coating, and/or epoxy. In general, the present invention may be used with any liquid.

Further, it is within the scope of the invention to use the loading system with applicators of various types (such as, but not limited to, brushes, rollers, edgers, corner painting tools, and pads). Certain aspects of the loading system may be adapted for use with certain applicators. For example, the displacement of the pump and/or the tray shape and/or features may be different for a loading system adapted for use with brushes than for a loading system adapted for use with rollers.

While exemplary embodiments of the invention have been set forth above for the purpose of disclosure, modifications of the disclosed embodiments of the invention as well as other embodiments thereof may occur to those skilled in the art. Accordingly, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the stated advantages or objects of the invention disclosed herein to fall within the scope of the claims, since inherent and/or unforeseen advantages of the present invention may exist even though they may not have been explicitly discussed herein.

What is claimed is:

1. A loading system comprising:
a base adapted to couple with a container holding a liquid;
a tray supported by the base; and
a pump adapted to discharge a portion of the liquid onto the tray.

2. The loading system of claim 1, wherein the tray includes a liquid return adapted to drain liquid from the tray into the container.

3. The loading system of claim 2, wherein the tray includes at least one surface feature.

4. The loading system of claim 3, wherein the tray includes a sloped floor, the pump discharges the liquid proximate a high portion of the tray, and the at least one liquid return is located proximate a low portion of the tray.

5. The loading system of claim 3, wherein the tray is adapted to load the portion of the liquid onto an applicator, wherein the applicator is at least one of the group consisting of a brush, roller, edger, cloth, corner painting tool, and pad.

6. The loading system of claim 3, wherein the at least one surface feature includes a plurality of truncated cones.

7. The loading system of claim 6, wherein at least one of the truncated cones includes a hole such that liquid may flow from within the tray to beneath the tray through the hole.

8. The loading system of claim 1, wherein the base includes at least one barb adapted to engage the container.

9. The loading system of claim 1, wherein the tray is releasably attached to the base.

10. The loading system of claim 1, wherein a displacement of the pump is approximately equal to a volume of liquid necessary to load an applicator.

11. The loading system of claim 10, Wherein the pump is a positive displacement pump comprising a piston slidable within a cylinder.

12. The loading system of claim 1, wherein the base includes a spout adapted to allow pouring of the liquid from the container while the loading system is attached to the container.

13. The loading system of claim 1, wherein the container is one of the group consisting of a can, a bucket, and a bottle.

14. The loading system of claim 1, wherein the base is adapted to releasably couple with the container and includes at least one barb adapted to engage the container and a spout adapted to allow pouring of the liquid from the container while the loading system is attached to the container;
wherein the tray is releasably attached to the base and includes a liquid return located proximate a low portion of the tray adapted to allow liquid to drain from the tray into the container, a sloped floor, and at least one surface feature including a plurality of truncated cones wherein at least one of the truncated cones includes a hole such that liquid may flow from within the tray to beneath the tray through the hole;
wherein the pump is a positive displacement pump comprising a piston slidable within a cylinder, the pump discharges the portion of the liquid proximate a high portion of the tray, and a displacement of the pump is approximately equal to a volume of liquid necessary to load an applicator;
wherein the container is taken from the group consisting of a can, a bucket, and a bottle; and
wherein the applicator is at least one of the group consisting of a brush, roller, edger, cloth, corner painting tool, and pad.

15. A loading system comprising:
a base adapted to releasably couple with a container holding a liquid;
a first tray adapted to releasably couple with the base and having at least one surface feature; and
a pump adapted to withdraw a portion of the liquid from the container and discharge the portion of the liquid into the first tray;
wherein the base and the tray cooperate to allow drainage from the tray into the container.

16. The loading system of claim 14, further comprising a second tray adapted to releasably couple with the base in place of the first tray such that the pump discharges the portion of the liquid into the second tray, the second tray having at least one surface feature that is different from the at least one surface feature of the first tray.

17. A method of loading an applicator with a liquid comprising the steps of:
providing a container holding a liquid;
providing a loading system, the loading system including a pump adapted to pump the liquid and a tray adapted to receive liquid discharged from the pump;
coupling the loading system to the container;
operating the pump to discharge a portion of the liquid onto the tray;
providing an applicator;
loading the applicator with at least some of the portion of the liquid in the tray.

18. The method of claim 17, wherein the liquid is at least one of the group consisting of paint, stain, oil, sealant, coating, and epoxy.

19. The method of claim 17, wherein the applicator is at least one of the group consisting of a brush, roller, cloth, edger, corner applicator, or pad.

20. The method of claim 17, further comprising the steps of operating the pump a second time and loading the applicator a second time following the completion of the step of loading the applicator.

21. The method of claim 20, further comprising the step of priming the pump prior to operating the pump to discharge a portion of the liquid onto the tray.
